(19) United States
(12) Patent Application Publication
(10) Pub. No.: US 2017/0152747 A1
(43) Pub. Date: Jun. 1, 2017

(54) DISK ASSEMBLY AND TURBINE INCLUDING THE SAME

(71) Applicant: DOOSAN HEAVY INDUSTRIES CONSTRUCTION CO., LTD., Gyeongsangnam-do (KR)

(72) Inventor: Kyung Kook KIM, Daejeon (KR)

(21) Appl. No.: 15/360,596

(22) Filed: Nov. 23, 2016

(30) Foreign Application Priority Data
Dec. 1, 2015 (KR) 10-2015-0169988

(51) Int. Cl. F01D 5/08; F01D 5/18; F01D 5/30; F04D 29/32

(52) U.S. Cl. CPC F01D 5/081; F04D 29/321; F01D 5/187; F01D 5/3007; F05D 2220/32; F05D 2260/20

(57) ABSTRACT

A disk assembly includes a first disk, a second disk and a third disk. The first disk is engaged with a compressor section of a gas turbine. The second disk is engaged with a turbine section of the gas turbine. The third disk is disposed between the first and second disks and transfers a rotational torque applied to the second disk to the first disk. A through-hole is defined through the third disk along an axial direction of the gas turbine. A distance between the third disk and a tie rod is less than each of distances between the first and second disks and the tie rod, such that spaces are defined as surfaces of the third disk respectively in communication with the compressor section and the turbine section.

### CROSS-REFERENCE(S) TO RELATED APPLICATION

This application claims priority to Korean Patent Application No. 10-2015-0169988, filed on Dec. 1, 2015, the disclosure of which is incorporated herein by reference in its entirety.

### BACKGROUND

Exemplary embodiments of the present disclosure relate to a disk assembly and a turbine including the same, and more particularly, to a disk assembly disposed between a compressor section and a turbine section in a gas turbine and transferring a rotational torque generated by the turbine section to the compressor section, and a turbine including the same.

A gas turbine is a kind of motor which acquires a rotational force by injecting combustion gas toward blades of a turbine, and may be divided into a compressor, a combustor and a turbine. The compressor serves to receive a part of power generated through rotations of the turbine, and compress introduced air at high pressure, and the compressed air is transferred to the combustor.

The combustor generates a high-temperature combustion gas flow by mixing and combusting the compressed air and fuel, and injects the generated combustion gas toward the turbine. The injected combustion gas rotates the turbine to generate a rotational force.

The compressor and the turbine include a plurality of rotor disks having blades radially coupled to the outer circumference thereof. Typically, the compressor includes a larger number of rotor disks than the turbine. Hereafter, the plurality of rotor disks arranged in the compressor is referred to as a compressor section, and the plurality of rotor disks arranged at the turbine is referred to as a turbine section.

Each of the rotor disks is coupled to an adjacent rotor disk such that the rotor disks are rotated together. Furthermore, the rotor disks are fixed against each other through a tie rod, and thus not moved in the axial direction.

The tie rod may be inserted through the centers of the respective rotor disks, and the rotor disks may be fastened through nuts coupled to both ends of the tie rod, and thus not moved in the axial direction.

Since the combustor is arranged between the compressor section and the turbine section, the compressor section and the turbine section are separated from each other so as to form a space in which the combustor is to be disposed. Since the tie rod restricts only the axial movement of the rotor disks, the rotor disks can be freely rotated about the tie rod. Thus, a torque transfer member must be additionally installed to transfer a rotational torque generated by the turbine section to the compressor section via the combustor.

An example of the torque transfer member is a torque tube. The torque tube has a hollow cylindrical shape, and both ends of the torque tube are coupled to the last rotor disk of the compressor section and the first rotor disk of the turbine section, respectively, such that a torque is transferred therebetween.

The torque tube must be resistant to deformation and distortion, because the gas turbine is continuously operated for a long term. Furthermore, the torque tube must be easily assembled/disassembled in order to facilitate maintenance. Furthermore, since the torque tube also functions as an air flow path through which cooling air supplied from the compressor section is transferred to the turbine section, the cooling air must be able to be smoothly supplied.

### BRIEF SUMMARY

The present disclosure has been made in view of the above problems, and it is an object of the present disclosure to provide a torque transfer unit which is enhanced more than a conventional torque tube.

Also, it is an object of the present disclosure to provide a turbine having a torque transfer unit.

Other objects and advantages of the present disclosure can be understood by the following description, and become apparent with reference to the embodiments of the present disclosure. Also, it is obvious to those skilled in the art to which the present disclosure pertains that the objects and advantages of the present disclosure can be realized by the apparatus and methods as claimed and combinations thereof.

In accordance with one aspect of the present disclosure, a disk assembly may include: a first disk engaged with a compressor section of a gas turbine; a second disk engaged with a turbine section of the gas turbine; a third disk disposed between the first and second disks, transferring a rotational torque applied to the second disk to the first disk, and having a through-hole formed therethrough along an axial direction of the gas turbine; and a damper ring disposed between the inner circumferential surface of the third disk and the outer circumferential surface of the tie rod of the gas turbine, and fixing the third disk in a radial direction of the tie rod. A distance between the third disk and a tie rod may be set to be smaller than distances between the first and second disks and the tie rod, such that the third disk has spaces formed at both surfaces thereof, the spaces communicating with the compressor section and the turbine section, respectively.

The first to third disks may have outer rims formed at the outside thereof in the radial direction, the outer rims being engaged with the compressor section and the turbine section, respectively.

The third disk may include an inner rim which is disposed at a more inner position in the radial direction than the outer rim, and faces the tie rod.

The second disk may have a through-hole formed between the outer rim and the tie rod.

The damper ring may be disposed between the inner rim and the tie rod.

The third disk may have first and second air storage spaces formed at both surfaces thereof, and the first and second air storage spaces may communicate with each other through the through-hole.

The first and second air storage spaces may include inner spaces of the first and second disks, respectively.

The outer surface of the inner rim in the radial direction may be formed with a tapered surface.

The third disk may have an H-shaped cross-section.

The third disk may have a T-shaped cross-section.

In accordance with another aspect of the present disclosure, a disk assembly may include: a first disk engaged with a compressor section of a gas turbine; a second disk engaged with a turbine section of the gas turbine; a third disk disposed between the first and second disks, and transferring a rotational torque applied to the second disk to the first disk; and a cooling air flow path formed through the first to third disks. The third disk may include a guide unit for increasing radial movement of cooling air passing through the cooling air flow path.

In accordance with another aspect of the present disclosure, a gas turbine may include: a compressor section having a plurality of compressor-side rotor disks; a turbine section having a plurality of turbine-side rotor disks arranged at the downstream side of the compressor-side rotor disks; a tie rod disposed through the rotor disks of the compressor section and the turbine section, and contacting the rotor disks with each other; and a disk assembly disposed between the compressor section and the turbine section.

It is to be understood that both the foregoing general description and the following detailed description of the present disclosure are exemplary and explanatory and are intended to provide further explanation of the invention(s) as claimed.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a cross-sectional view schematically illustrating the internal structure of a gas turbine to which a disk assembly according to a first embodiment of the present disclosure is applied;

FIG. 2 is an expanded cross-sectional view of the first embodiment of FIG. 1; and

FIG. 3 is an expanded cross-sectional view of a disk assembly according to a second embodiment of the present disclosure.

### DETAILED DESCRIPTION

Hereafter, referring to the accompanying drawings, a disk assembly and a gas turbine including the same according to an embodiment of the present disclosure will be described in detail.

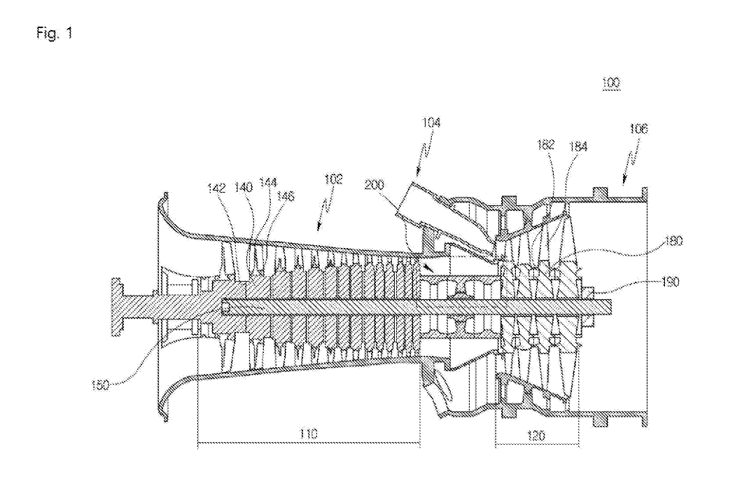

FIG. 1 is a cross-sectional view schematically illustrating the internal structure of a gas turbine 100 to which a disk assembly 200 according to a first embodiment of the present disclosure is applied. Referring to FIG. 1, the turbine 100 includes a body 102 and a diffuser 106. The diffuser 106 is disposed at the rear of the body 102 and discharges combustion gas passed through the turbine. The turbine 100 further includes a combustor 104 disposed at the front of the diffuser 106, and receiving and combusting compressed air.

Based on an air flow direction, a compressor section 110 is positioned at the upstream side of the body 102, and a turbine section 120 is disposed at the downstream side of the body 102. Between the compressor section 110 and the turbine section 120, a disk assembly 200 is disposed as a torque transfer member which transfers a rotational torque generated by the turbine section to the compressor section. The compressor section 110 includes a total of 14 compressor rotor disks 140, and the compressor rotor disks 140 are fastened to each other through one tie rod 150 so as not to be separated from each other in the axial direction.

Specifically, the compressor rotor disks 140 are arranged along the axial direction while the tie rod is inserted through the centers of the compressor rotor disks 140. Each of the compressor rotor disks 140 includes a plurality of protrusions formed around the outer circumference thereof, and has a flange 142 protruding in the axial direction so as not to be relatively rotated about an adjacent rotor disk.

The compressor rotor disk 140 has a plurality of blades 144 radially coupled to the outer circumferential surface thereof. Each of the blades 144 is coupled to the compressor rotor disk 140 through a dove tail part 146. However, the coupling method between the blade 144 and the compressor rotor disk 140 is not limited to the dove tail.

The turbine section 120 includes four turbine rotor disks 180. Each of the turbine rotor disks 180 basically has a similar shape to the compressor rotor disk. Therefore, the turbine rotor disk 180 also has a flange 182 having coupling protrusions coupled to an adjacent turbine rotor disk, and includes a plurality of turbine blades 184 which are radially arranged. Each of the turbine blades 184 may also be coupled to the turbine rotor disk 180 through a dove tail part.

The tie rod 150 is disposed through the centers of the plurality of compressor rotor disks 140. One end of the tie rod 150 is fastened to the compressor rotor disk positioned at the most upstream side, and the other end thereof is fastened to a fixing nut 190 disposed at the downstream side of the turbine rotor disk positioned at the most downstream side. Specifically, the other end of the tie rod 150 is screwed to the fixing nut 190, and the fixing nut pressurizes the turbine-side rotor disk disposed at the most downstream side in the axial direction. Thus, the plurality of disks arranged along the tie rod 150 are fixed against each other so as not to be moved in the axial direction.

The disk assembly 200 is fixed in a state where both ends thereof are in contact with the compressor section 110 and the turbine section 120, respectively. That is, the compressor section-side end of the disk assembly is in contact with the compressor rotor disk at the most downstream side, and the turbine section-side end of the disk assembly is in contact with the turbine rotor disk at the most upstream side. As described above, the disk assembly has a plurality of protrusions formed thereon, and may be fixed so as not to relatively rotate about the rotor disks.

The above-described gas turbine has a structure in which one tie rod is extended across the compressor and turbine. However, the structure is not limited thereto. For example, a structure in which separate tie roads are installed at the compressor and the turbine, respectively, may be considered. Instead of one tie road disposed through the centers of the respective disks, a structure having a plurality of tie rods radially arranged through the disks may be considered. In another example, one tie rod may be disposed through the center of any one of the compressor section and the turbine section, and a plurality of tie rods may be radially arranged through the other section.

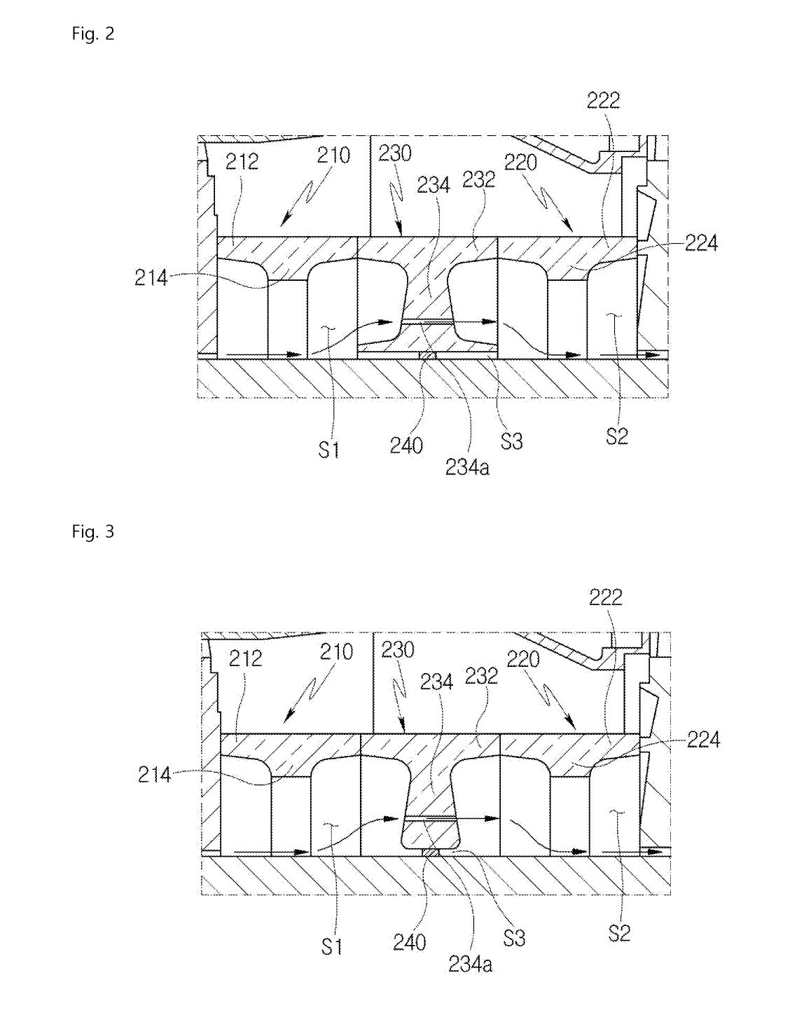

Now, referring to FIG. 2, the disk assembly 200 will be described in detail.

Referring to FIG. 2, the disk assembly 200 includes three disks. Each of the three disks commonly has a hole formed in the center thereof, such that the tie rod passes through the hole. However, while the first and second disks 210 and 220 have substantially the same shape, the third disk 230 has a smaller inner diameter than the first and second disks. Hereafter, the disks will be described in detail.

The first disk 210 has a T-shaped side cross-section. Specifically, the first disk includes a disk body 214 and an outer rim 212. The outer rim 212 is formed at the outer circumference of the disk body 214 so as to protrude toward both sides along the axial direction of the tie rod. The outer rim 212 is disposed against the adjacent disks, and coupled to the disks such that the disks do not relatively rotate about each other. For example, the outer rim 212 having a friction surface formed thereon may be coupled to the compressor-side rotor disk or the third disk by a pressurizing force of the fixing nut. Thus, the outer rim 212 may not be slid on the surface of the compressor-side rotor disk or the third disk. Besides, the outer rim 212 may be fastened to the adjacent disks through a plurality of protrusions formed on the surface thereof.

One end of the disk body 214 of the first disk, or specifically an end facing the tie rod 150 is spaced from the surface of the tie rod. Specifically, the first disk has a cross-section of which the height is smaller than the width thereof, based on FIG. 2. Thus, the first disk has an internal space in which the tie rod is disposed. The internal space and a side surface of the third disk to be described later form a first air storage space S1. The first air storage space S1 will be described later.

The second disk 220 basically has a similar shape to the first disk. That is, the second disk 220 may also have a T-shaped side cross-section. Like the first disk, the second disk 220 includes a disk body 224 and an outer rim 222. The outer rim 222 is formed at the outer circumference of the disk body so as to protrude toward both sides along the axial direction of the tie rod. The outer rim 222 of the second disk 220 is also disposed against the adjacent disks, and coupled to the disks such that the disks do not relatively rotate about each other.

For example, the outer rim 222 having a friction surface thereon may be coupled to the turbine-side rotor disk or the third disk by a pressurizing force of the fixing nut. Thus, the outer rim 222 may not be slid on the surface of the turbine-side rotor disk or the third disk. The outer rim 222 may also be fastened to the adjacent disks through a plurality of protrusions formed on the surface thereof.

The second disk forms a second air storage space S2 similar to the air storage space of the first disk.

The third disk has a different shape from the first and second disks. As illustrated in FIG. 2, the third disk 230 is formed in an H-shape. Specifically, the third disk 230 includes a disk body 234 and an outer rim 232 formed on the outside of the disk body in the radial direction. The outer rim 232 may have the same shape as those of the first and second disks. The disk body 234 has a through-hole 234a extending along the longitudinal direction of the tie rod 150.

The through-hole 234a functions as a flow path through which cooling air is passed. FIG. 2 illustrates that the through-hole is formed in parallel to the longitudinal direction of the tie rod. However, the through-hole 234a is not limited thereto, but may have an arbitrary shape as long as the through-hole is formed through the disk body 234.

For example, the through-hole may be inclined in a lower-right or upper-right direction based on FIG. 2.

The disk body 234 has an inner rim 236 formed therein in the radial direction thereof. The inner rim 236 is extended along the longitudinal direction of the tie rod from both surfaces of the disk body 234. Based on FIG. 2, the top surface of the inner rim 236 is formed with a tapered surface.

The third disk 230 has a hole formed in the center thereof such that the tie rod 150 is passed through the hole. The hole has a smaller inner diameter than those of the first and second disks. Thus, as illustrated in FIG. 2, first and second air storage spaces S1 and S2 are defined at both surfaces of the main body of the third disk 230. The first and second air storage spaces S1 and S2 are defined by the internal spaces of the first and second disks and the spaces existing at both surfaces of the disk body of the third disk.

The first air storage space S1 formed between the first and second disks functions as a space in which cooling air extracted from the compressor section is primarily stored. The second air storage space S2 functions as a space in which cooling air to be injected to the turbine section temporarily stays.

The through-hole 234a serves to connect the two air storage spaces S1 and S2 to each other. Thus, the cooling air stored in the first air storage space may be introduced into the second air storage space through the through-hole 234a. The introduced cooling air temporarily stays in the second air storage space, and is then supplied toward the turbine section.

At this time, the tapered surface disposed before and after the through-hole 234a serves to guide the cooling air to naturally head toward the through hole. Thus, the cooling air flows along the tie rod in the first and second disks. In the third disk, however, the cooling air flows while being separated from the tie rod. Based on FIG. 2, the cooling air rises and falls before and after the second disk. Such a structure increases the momentum of the cooling air in the vertical direction (based on FIG. 2), such that the cooling air can be uniformly mixed.

As illustrated in FIG. 2, the disk assembly according to the first embodiment has a structure in which the second disk having a relatively small inner diameter is disposed between the two disks having the inner rim facing the tie rod 150. Thus, while the disk assembly is stably supported with respect to the tie rod, the weight thereof can be reduced or minimized.

Furthermore, in the first embodiment, the coupling among the three disks having ends facing the tie rod 150 is maintained by the axial pressure of the tie rod. At this time, in order to support the first to third disks in the radial direction, a tension ring 240 is inserted between the end of the third disk and the tie rod 150.

The tension ring 240 is made of an elastic material. Based on FIG. 2, the top surface of the tension ring 240 is supported against the inner rim 236, and the bottom surface of the tension ring 240 is supported against the outer circumferential surface of the tie rod 150. Therefore, the tension ring can absorb vibration which may be generated during operation, reduce or prevent a reduction in life time of the device, and reduce or minimize an occurrence of noise.

In the example illustrated in FIG. 2, only the third disk includes the tension ring. This is because vibration can be absorbed to a required extent by one tension ring, since the three disks are fixed against each other between the compressor and turbine sections in the axial direction by the tie rod. Furthermore, that is in order to allow cooling air to flow through the third disk.

In the above-described embodiment, an H-shaped disk is arranged between two T-shaped disks. However, the number of disks and the arrangement order thereof may be changed. Furthermore, the first and second disks are separated from each other, and supported against each other through the third disk. In order to improve the vibration absorption performance, an additional member may be installed to connect the first and second disks.

FIG. 3 illustrates a disk assembly according to a second embodiment. The second embodiment basically has the same structure as the first embodiment. However, the second embodiment is different from the first embodiment in that the third disk has a T-shape instead of an H-shape. That is, the third disk according to the second embodiment does not have an inner rim which is included in the third disk according to the first embodiment. Therefore, the entire weight of the disk assembly can be further reduced.

In accordance with the embodiments of the present disclosure, since the disk assembly uses the plurality of disks as a torque transfer member, a fixing operation for the tie rod may be facilitated. Furthermore, since one or more disks are supported against the tie rod by the tension ring in the radial direction, vibration and noise caused by the disk assembly can be minimized during the torque transfer process.

Furthermore, since two disks having a small weight are disposed at both sides of the third disk positioned in the center, the structural stability can be further improved. It will be apparent to those skilled in the art that various changes and modifications may be made without departing from the spirit and scope of the following claims.

Moreover, the above advantages and features are provided in described embodiments, but shall not limit the application of the claims to processes and structures accomplishing any or all of the above advantages.

What is claimed is:

1. A disk assembly, comprising:
a first disk engaged with a compressor section of a gas turbine;
a second disk engaged with a turbine section of the gas turbine; and
a third disk disposed between the first and second disks and operable to transfer a rotational torque applied to the second disk to the first disk, wherein
a through-hole is defined through the third disk along an axial direction of the gas turbine, and
a distance between the third disk and a tie rod is less than each of distances between the first and second disks and the tie rod, such that spaces are defined as surfaces of the third disk respectively in communication with the compressor section and the turbine section.

2. The disk assembly of claim 1, further comprising a damper ring disposed between an inner circumferential surface of the third disk and an outer circumferential surface of the tie rod of the gas turbine, the damper ring being operable to fix the third disk in a radial direction of the tie rod.

3. The disk assembly of claim 1, wherein the first, second and third disks each have an outer rim at the outside of the disk in the radial direction, the outer rims being engaged with the compressor section and the turbine section, respectively.

4. The disk assembly of claim 3, wherein the third disk includes an inner rim that faces the tie rod and is disposed at a more inner position in the radial direction than the outer rim.

5. The disk assembly of claim 3, wherein a through-hole is defined through the second disk between the outer rim and the tie rod.

6. The disk assembly of claim 4, further comprising a damper ring disposed between the inner rim and the tie rod.

7. The disk assembly of claim 1, wherein first and second air storage spaces re defined at surfaces of the third disk, and the first and second air storage spaces are in communication with each other through the through-hole.

8. The disk assembly of claim 7, wherein the first and second air storage spaces include inner spaces of the first and second disks, respectively.

9. The disk assembly of claim 4, wherein an outer surface of the inner rim in the radial direction includes a tapered surface.

10. The disk assembly of claim 1, wherein the third disk has an H-shaped cross-section.

11. The disk assembly of claim 1, wherein the third disk has a T-shaped cross-section.

12. A disk assembly, comprising:
a first disk engaged with a compressor section of a gas turbine;
a second disk engaged with a turbine section of the gas turbine;
a third disk disposed between the first and second disk and operable to transfer a rotational torque applied to the second disk to the first disk; and
a cooling air flow path defined through the first, second and third disks,
wherein
the third disk includes a guide to increase radial movement of cooling air passing through the cooling air flow path.

13. The disk assembly of claim 12, wherein
the third disk includes an inner rim that faces the tie rod, and
a surface of the inner rim of the guide unit is tapered.

14. The disk assembly of claim 13, wherein the third disk includes
a disk body radially extending from the inner rim, and
two tapered surfaces disposed around the disk body.

15. The disk assembly of claim 14, wherein a through-hole is defined through the disk body, and the cooling air flow path includes the through-hole.

16. The disk assembly of claim 13, wherein the inner rim of the third disk and the tie rod are spaced from each other.

17. The disk assembly of claim 16, further comprising a damper ring disposed between the inner rim and the tie rod, the damper ring being operable to fix the third disk in the radial direction of the tie rod.

18. A gas turbine comprising:
a compressor section having a plurality of compressor-side rotor disks;
a turbine section having a plurality of turbine-side rotor disks arranged at a downstream side of the compressor-side rotor disks;
a tie rod disposed through the rotor disks of the compressor section and the turbine section, and contacting the rotor disks with each other; and
a disk assembly disposed between the compressor section and the turbine section, the disk assembly including:
a first disk engaged with a compressor section of a gas turbine;
a second disk engaged with a turbine section of the gas turbine; and
a third disk disposed between the first and second disks and operable to transfer a rotational torque applied to the second disk to the first disk, wherein
a through-hole is defined through the third disk along an axial direction of the gas turbine, and
a distance between the third disk and a tie rod is less than each of distances between the first and second disks and the tie rod, such that spaces are defined as surfaces of the third disk respectively in communication with the compressor section and the turbine section.

19. The gas turbine of claim 18, further comprising a cooling air flow path including the through-hole and the spaces.

20. The gas turbine of claim 19, wherein a portion of the cooling air flow path is spaced from the tie rod.
